(19) United States
(12) Patent Application Publication
(10) Pub. No.: US 2006/0096543 A1
(43) Pub. Date: May 11, 2006

(54) Dog bed made from sisal material

(76) Inventor: Edward P. Dennis, Evergreen, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/269,297

(22) Filed: Nov. 8, 2005

Related U.S. Application Data
(60) Provisional application No. 60/626,712, filed on Nov. 10, 2004.

(51) Int. Cl. A01K 1/035

(52) U.S. Cl. 119/28.5

(57) ABSTRACT

A pet bed such as a dog bed made with sisal material. The dog bed includes an outer covering and a filler material, at least one of which is made from sisal material.

### CROSS REFERENCE TO RELATED APPLICATIONS

This application claims priority to U.S. Provisional Application No. 60/626,712 entitled DOG BED MADE FROM SISAL MATERIAL and filed Nov. 10, 2004, the disclosure of which is incorporated herein by reference in its entirety.

### FIELD OF THE INVENTION

The present invention relates to a dog bed made of sisal material.

### BACKGROUND OF THE INVENTION

Many dog owners purchase dog beds to provide their dogs with a place to sleep or lay. Dog beds are made from an outer covering that is filled with various filler materials. One specific kind of filler material that is commonly used is wood shavings. The wood shavings are usually made from redwood or pine. Wood shavings are a desirable filler material because they are a natural material, which appeals to many consumers. Also, the wood shavings have a strong scent that masks any odors from a dog.

Despite the advantages of using wood shavings as filler material, there are also some very severe disadvantages to the use of wood shavings. For example, the oils that are responsible for the strong scent in cedar shavings may affect an animal's metabolism and liver function. Additionally, the scented oil in cedar shavings may damage an animal's sense of smell and are carcinogenic. Wood shavings also create wood dust, which can cause allergic reactions in dogs and humans and may trigger asthma attacks or other respiratory problems. Natural wood also contains phenols, which have been linked to problems in dogs such as kidney damage, liver damage, pulmonary infections, and symptoms of premature aging.

Thus, there is a need for dog beds made of materials that provide the advantages of wood shavings, such as being a natural material and having a natural fragrance, but does not have the disadvantages of wood shavings.

### SUMMARY OF THE INVENTION

In one embodiment of the present invention, an outer covering for a dog bed is made of a sisal material. The outer covering may comprise at least 10 weight percent, at least 20 weight percent, at least 30 weight percent, at least 50 weight percent, at least 75 weight percent or 100 weight percent sisal material. The outer covering may comprise up to 10 weight percent, up to 25 weight percent or even up to 30 weight percent sisal material. The remaining portion of the outer covering may comprise any material that is useful in making an outer covering for a dog bed; some nonlimiting examples include nylon, rayon, cotton, polyester, wool, other materials for making cloth and any combinations thereof.

In a second embodiment of the present invention, a filler material for filling a dog bed is made of a sisal material. The filler material may comprise at least 50 weight percent, at least 75 weight percent or 100 weight percent sisal material. It is possible that the filler material comprise up to 10 weight percent sisal material, it may comprise up to 30 weight percent sisal material, or even up to 40 weight percent sisal material. The remaining portion of the filler material may comprise any suitable material for filling a dog bed. Some nonlimiting examples include nylon, rayon, cotton, polyester, wool, other materials for making cloth, down, wood shavings and any combinations thereof.

In a third embodiment of the present invention, both an outer covering and a filler material of a dog bed comprise sisal material. In this embodiment of the present invention, the outer covering and the filler material may be any combination of the outer covering and filler material described above with respect to the first two embodiments. For example, the outer covering may be made completely of sisal material and the filler material may also be made completely of sisal material. As another example, the outer covering may be made entirely from a non-sisal material, and the filler material may be made completely of a sisal material. Yet another example, the outer material may be made completely from sisal material and the filler material may be made completely of a non-sisal material. The foregoing are only illustrative examples.

### BRIEF DESCRIPTION OF THE DRAWING

FIG. 1 shows two photographs of a dog bed in accordance with an embodiment of the present invention.

### DESCRIPTION OF THE INVENTION

The present invention relates to the use of sisal material in construction of a dog bed. The present invention comprises various embodiments wherein the sisal material is used in an outer covering of a dog bed, in a filler material of a dog bed or both. By “sisal material” or “sisal”, it is meant a fibrous material that is derived from an agave plant.

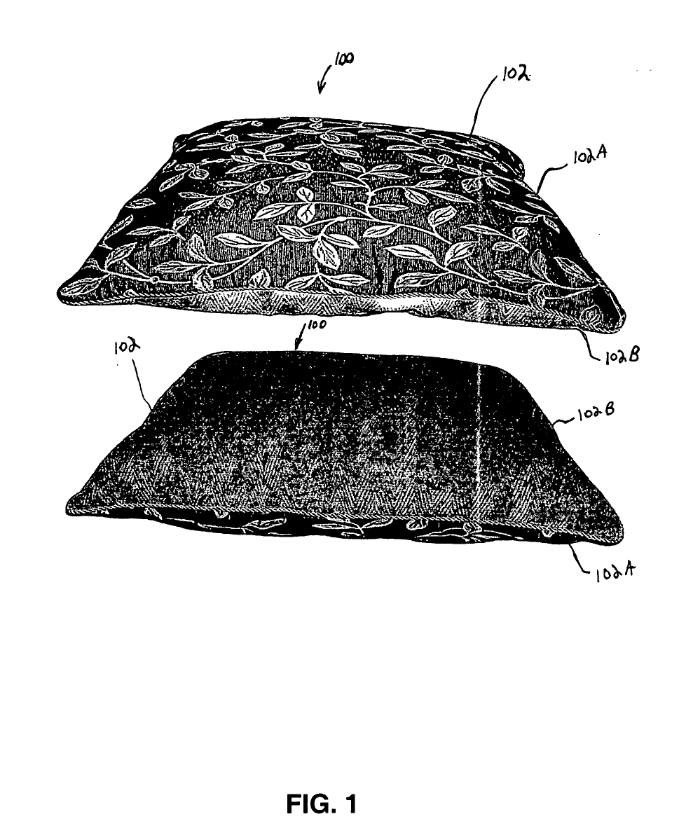

FIG. 1 shows two photographs, a top photograph and a bottom photograph of a dog bed in accordance with one embodiment of the present invention. The top photograph shows a perspective view of a dog bed 100 and the bottom photograph shows a perspective view of the dog bed turned 180°. The dog bed 100 has an outer covering 102. The outer covering 102 is made of cloth. As seen in FIG. 1, the cloth outer covering 102 is made of two separate pieces, 102A and 102B that are sewn together to form the outer covering 102. In other embodiments, the outer covering 102 may be made of a single piece of cloth or more than two pieces of cloth. The outer covering 102 is made of a cloth material that is pleasant and comfortable for a dog to sleep or lay on.

The dog bed 100 also includes a filler material—not shown in FIG. 1. The filler material is used to occupy at least a portion of an inner volume defined by outer covering 102. The filler material is made of a material that in combination with the outer covering 102 will be pleasant and comfortable for a dog to sleep or lay on. The filler material may be in any suitable form for occupying the volume defined by the outer covering, nonlimiting examples include small pieces, large pieces, strands, long fibers, long braided fibers, short fibers or any combination thereof.

As seen in FIG. 1, the outer covering 100 is sewn to completely seal off the inner volume defined by the outer covering 100 from the surrounding environment. It is important to note that is some embodiments, the inner volume defined by the outer covering 100 may not be completely sealed. This may be important for allowing a dog owner to refill the dog bed 100 with additional filler material.

In a first embodiment of the present invention, the outer covering is made using sisal. The outer covering may comprise at least 35 weight percent sisal, at least 45 weight percent sisal, at least 65 weight percent sisal or even at least 95 weight percent sisal. By “50 weight percent sisal” it is meant that 35 weight percent of the total outer covering is made of sisal. The outer covering may comprise up to 5 weight percent sisal, up to 15 weight percent sisal or even up to 25 weight percent sisal. The remaining portion of the outer covering may comprise any suitable material for constructing an outer covering of a dog bed, nonlimiting examples including nylon, rayon, cotton, polyester, wool, other material for making cloth and any combinations thereof. In this embodiment of the present invention, the filler material may comprise the filler material that is described below with respect to the second embodiment. However, in some embodiments the filler material used in this embodiment may comprise only non-sisal materials nonlimiting examples including nylon, rayon, cotton, polyester, wool, down, wood shavings, other cloth materials and any combinations thereof.

In one implementation of the first embodiment, a dog bed is made with one half of the outer covering comprising sisal. In this implementation, the half of the outer covering that includes sisal comprises 100 weight percent sisal and the other half of the outer covering is made from 100 weight percent non-sisal material. The two pieces are sewn together to form the outer covering for a dog bed. It should be noted that just because half of the outer covering comprises 100 weight percent sisal and the other half comprises no sisal, the total weight percent of sisal in the outer covering does not necessarily comprise 50 weight percent, rather the outer covering may comprise: 50 weight percent sisal, more than 50 weight percent sisal or less than 50 weight percent sisal. The filler material in this implementation is made entirely of a non-sisal material.

In a second implementation of the first embodiment of the invention, a dog bed is made with an outer covering that comprises 100 weight percent sisal. In this implementation, the filler material is made entirely of a non-sisal material.

In a second embodiment of the present invention, the filler material includes sisal. The filler material may comprise at least 45 weight percent sisal, at least 65 weight percent or even as much as at least 95 weight percent sisal. By “45 weight percent sisal” it is meant 45 weight percent of the total filler material is made of sisal. The filler material may comprise up to 5 weight percent sisal, up to 15 weight percent sisal or even up to 25 weight percent sisal. The remaining portion of the filler material may comprise any suitable material for filling a dog bed. Some nonlimiting examples include nylon, rayon, cotton, polyester, wool, down, wood shavings, other cloth material and any combinations thereof. In this embodiment of the present invention, an outer covering of the dog bed may be made from the materials disclosed above with respect to the first embodiment. Alternatively, the outer covering may be made completely from non-sisal materials some nonlimiting examples including nylon, rayon, cotton, polyester, wool, other materials for making cloth and any combinations thereof.

In a third embodiment of the present invention, both an outer covering and a filler material of a dog bed comprise sisal. In this embodiment of the present invention, the outer covering and the filler material may be any combination of the outer covering and filler material described above with respect to the first two embodiments.

The present invention provides a variety of advantages over the use of other material for construction of a dog bed. For example, the fact that sisal is a natural material is appealing to many consumers—i.e. dog owners. Additionally, sisal has some flame retardant qualities, is environmentally friendly to produce, is biodegradable and has a neutral carbon dioxide balance when disposed of. Moreover, sisal provides the benefits of being antistatic, which repels dirt and dust. The antistatic properties of sisal advantageously alleviate allergies, of dogs and humans, caused by the collection of allergens and dust mites on a dog bed. Finally, sisal has a clean natural fragrance.

The foregoing discussion of the invention has been presented for purposes of illustration and description and to disclose the best mode contemplated for practicing the invention. The foregoing is not intended to limit the invention to only the form or forms specifically disclosed herein. Although the description of the invention has included description of one or more embodiments and certain variations and modifications, other variations and modifications are within the scope of the invention, e.g., as may be within the skill and knowledge of those in the art after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Furthermore, any feature described with respect to any disclosed embodiment may be combined in any combination with one or more features of any other embodiment or embodiments.

The terms “comprising”, “containing”, “including” and “having”, and variations thereof, are intended to be inclusive and nonlimiting in that the use of such terms indicates the presence of some condition or feature, but not to the exclusion of the presence also of any other condition or feature.

What is claimed is:

1. A dog bed comprising:
an outer covering which defines a volume;
a filler material used to occupy at least a portion of the volume; and
wherein at least one of the outer covering and the filler material comprises sisal.

2. The dog bed of claim 1, wherein both said outer covering and said filler material comprise sisal.

3. The dog bed of claim 1, wherein only said filler material comprises sisal.

4. The dog bed of claim 1, wherein only said outer covering comprises sisal.

5. The dog bed of claim 3, wherein said filler material comprises 100 weight percent sisal.

6. The dog bed of claim 1, wherein said outer covering comprises 100 weight percent sisal.

7. The dog bed of claim 1, wherein said outer covering comprises at least 20 weight percent sisal.

8. The dog bed of claim 1, wherein at least one of said outer covering and said filler material comprises from about 1 to 99 weight percent sisal.

9. The dog bed of claim 1, wherein at least one of said outer covering and said filler material comprises from 20 to 80 weight percent sisal.

10. The dog bed of claim 1, wherein at least one of said outer covering and said filler material comprises from about 40 to 60 weight percent sisal.

11. The dog bed of claim 1, wherein at least one of said outer covering and said filler material comprises from 45 to 55 weight percent sisal.
